(19) United States
(12) Patent Application Publication
(10) Pub. No.: US 2011/0240922 A1
(43) Pub. Date: Oct. 6, 2011

(54) SEMICONDUCTOR NANOCRYSTAL AND METHOD OF PREPARING THE SAME

(75) Inventors: Shin-Ae JUN, Seongnam-si (KR); Eun-Joo JANG, Suwon-si (KR); Hyo-Sook JANG, Yongin-si (KR); Mi-Jeong SONG, Suwon-si (KR)

(73) Assignee: SAMSUNG ELECTRONICS CO., LTD., Suwon-si (KR)

(21) Appl. No.: 12/946,667

(22) Filed: Nov. 15, 2010

(30) Foreign Application Priority Data
Mar. 30, 2010 (KR) 10-2010-0028460

(51) Int. Cl. C09K 11/02

(52) U.S. Cl. 252/301.36

(57) ABSTRACT

A method of preparing a semiconductor nanocrystal including a core or a core and a shell. The method includes contacting (A) a Group II precursor bound with phosphine, a Group III precursor bound with phosphine, or a mixture thereof, and (B) a Group V compound, a Group VI compound, or a mixture thereof, to provide the core or the core and the shell of the semiconductor nanocrystal.

### CROSS-REFERENCE TO RELATED APPLICATION

This application claims priority to Korean Patent Application No. 10-2010-0028460 filed on Mar. 30, 2010, and all the benefits accruing therefrom under 35 U.S.C. §119, the content of which in its entirety is herein incorporated by reference.

### BACKGROUND

1. Field

This disclosure relates to a semiconductor nanocrystal and a method of manufacturing the same.

2. Description of the Related Art

A semiconductor nanocrystal, which is also called a quantum dot, is a semiconductor material having a nanometer-scale crystalline structure and including hundreds to thousands of atoms.

Because the semiconductor nanocrystal is very small, the surface area per unit volume is large and it exhibits a quantum confinement effect. Therefore, the semiconductor nanocrystal provides unique physiochemical characteristics that are different from the intrinsic characteristics of a corresponding bulk material.

Particularly, the photoelectronic characteristics of a nanocrystal may be controlled by selecting the size and composition of the nanocrystal to provide high quantum yield (“QY”) and color purity. Also, researchers are studying application of semiconductor nanocrystals to a display device or a bioluminescent light-emitting device.

It has been reported that commercially available semiconductor nanocrystals including Cd provide excellent characteristics, but environmental issues relating to Cd have drawn attention. Therefore, efforts have been made to develop an environmentally-friendly and human-safe nano-sized light-emitting material which does not include Cd (i.e., a Cd-free material). A lot of research on Group III-V semiconductor nanocrystals has been performed to provide a Cd-free alternative, however a Cd-free precursor is sensitive to oxidation during synthesis, as compared to a semiconductor nanocrystal including CdSe, deteriorating the precursor activity. Thereby, it is difficult to control the synthesis of the Cd-free nanocrystal, and the synthesized material has inferior light emitting characteristics compared to the Cd-containing semiconductor nanocrystal, which includes CdSe. In order to apply an environmentally-friendly Cd-free semiconductor nanocrystal to a display element, or the like, there remains a need for techniques which enhance the luminous efficiency and the color purity of semiconductor nanocrystals.

### SUMMARY

An aspect provides a semiconductor nanocrystal having a high luminous efficiency.

Another aspect provides a semiconductor nanocrystal having high color purity.

Another aspect provides a method of manufacturing the semiconductor nanocrystal.

Another aspect provides a composition including the semiconductor nanocrystal.

Another aspect provides a semiconductor nanocrystal composite.

Another aspect provides a light emitting element including the semiconductor nanocrystal.

According to an aspect, a method of preparing a semiconductor nanocrystal including a core or a core and a shell is provided that includes contacting (A) a Group II precursor bound with phosphine, a Group III precursor bound with phosphine, or a mixture thereof, and (B) a Group V compound, a Group VI compound, or a mixture thereof to provide the core or the core and the shell of the semiconductor nanocrystal.

At least one of the Group II precursor bound with phosphine or the Group III precursor bound with phosphine may be represented by the following Chemical Formula 1:

Chemical Formula 1

MK_{y}(PHₓL₃₋ₓ)_{z}

wherein in Chemical Formula 1, M is a Group II element or Group III element, K is a carboxyl group, a phosphonyl group, an amino group, a sulfonyl group, a halide, a substituted or unsubstituted C₁-C₂₀ alkyl group, a substituted or unsubstituted C₁-C₂₀ alkoxy group, a substituted or unsubstituted C₆-C₃₀ aryl group, a substituted or unsubstituted C₆-C₃₀ aryloxy group, a substituted or unsubstituted C₁-C₂₀ haloalkyl group, or a combination thereof, L is a substituted or unsubstituted C₁-C₂₀ alkyl group, a substituted or unsubstituted C₁-C₂₀ alkoxy group, a substituted or unsubstituted C₆-C₃₀ aryl group, a substituted or unsubstituted C₆-C₃₀ aryloxy group, an oxy group, a halide, a substituted or unsubstituted C₁-C₂₀ haloalkyl group, a primary amino group, a secondary amino group, or a combination thereof, x is 0, 1, 2, or 3, y and z are each independently equal to or more than 0, provided that y+z is from 3 to 5, and wherein each PHₓL₃₋ₓ group, each K, and each L is independently the same of different.

The contacting may be performed in a solvent.

The method may further include contacting a Group III compound and a phosphine compound to provide a Group III precursor bound with phosphine, or contacting a Group II compound and a phosphine compound to provide a Group II precursor bound with phosphine.

The method may further include alloying a transition element with at least one of the core or the shell.

The transition element may include Zn, Mn, Cu, Fe, Ni, Co, Cr, V, Ti, Zr, Nb, Mo, Ru, Rh, Cd, or a combination thereof.

The method may further include binding an organic ligand represented by the following Chemical Formula 2 to the semiconductor nanocrystal:

Chemical Formula 2

X—R—Y

wherein, in Chemical Formula 2, R is a hydrocarbon group, X is SH, PH₃, R′R″P═O wherein R′ and R″ are each independently a C₁-C₅ alkyl group, NH₂, or COOH, and Y is H, OH, NR′R″, NH₂, COOH, or SO₃H.

According to an aspect, a method of manufacturing a core of a semiconductor nanocrystal is provided that includes preparing a solution including (A) a Group II compound, a Group III compound, or a mixture thereof, (B) a phosphine compound, and (C) a surfactant; and adding (D) a Group V compound, a Group VI compound, or a mixture thereof to the solution to provide the core of the semiconductor nanocrystal.

According to another aspect, a method of manufacturing a shell of a semiconductor nanocrystal is provided that includes providing a solution including (A) a Group II compound, a Group III compound, or a mixture thereof, (B) a phosphine compound, and (C) a surfactant; and adding a mixture including (D) a Group V compound, a Group VI compound, or a mixture thereof to the solution to provide the shell on a core, wherein the core is formed from the solution comprising (A) a Group II compound, a Group III compound, or a mixture thereof, (B) a phosphine compound, and (C) a surfactant, and (D) a Group V compound, a Group VI compound, or a mixture thereof, or the core is provided separately.

The phosphine compound may be represented by the following Chemical Formula 3:

Chemical Formula 3

PHₓL₃₋ₓ

wherein, in Chemical Formula 3, L is a substituted or unsubstituted C₁-C₂₀ alkyl group, a substituted or unsubstituted C₁-C₂₀ alkoxy group, a substituted or unsubstituted C₆-C₃₀ aryl group, a substituted or unsubstituted C₆-C₃₀ aryloxy group, an oxy group, a halide, a substituted or unsubstituted C₁-C₂₀ haloalkyl group, a primary amino group, a secondary amino group, or a combination thereof, x is 0, 1, 2, or 3, and each L is independently the same of different.

The phosphine compound may include tributyl phosphine, dibutyl phosphine, trioctyl phosphine, dioctyl phosphine, triphenyl phosphine, diphenyl phosphine, triethyl phosphite, dibutyl phosphite, or a mixture thereof.

The surfactant may include a saturated or unsaturated C₆-C₂₄ carboxylic acid, a saturated or unsaturated C₆-C₂₄ phosphate, a saturated or unsaturated C₆-C₂₄ sulfate, a saturated or unsaturated C₆-C₂₄ sulfonate, a saturated or unsaturated C₆-C₂₄ amine, or a combination thereof.

The method may further include alloying a transition element with at least one of the core or the shell.

The core may include a Group II-VI semiconductor, a Group III-V semiconductor, a Group IV semiconductor, a Group IV-VI semiconductor, a metal, or a mixture thereof.

According to another aspect, a semiconductor nanocrystal composition includes a Group III precursor bound with phosphine, a Group II precursor bound with phosphine, or a mixture thereof, and a surfactant.

The composition may further include a Group V compound, a Group VI compound, or a mixture thereof.

The composition may further include an organic solvent.

The composition may further include a precursor including a transition element.

A semiconductor nanocrystal may be manufactured using the semiconductor nanocrystal composition.

A semiconductor nanocrystal composite may include the composition for a semiconductor nanocrystal.

The light emitting element according to another aspect may include the semiconductor nanocrystal.

### BRIEF DESCRIPTION OF THE DRAWINGS

The above and other aspects, advantages and features of this disclosure will become more apparent by describing in further detail exemplary embodiments thereof with reference to the accompanying drawings, in which:

FIG. 1 is a graph of relative transmittance (percent) versus wavenumber (inverse centimeters) and is an infrared spectrum of a Group III precursor;

FIG. 2 is a transmission electron micrograph of nanocrystals obtained from Example 7;

FIG. 3 is a cross-sectional view of an exemplary embodiment of a light emitting element including the semiconductor nanocrystal; and

FIG. 4 is a cross-sectional view of an exemplary embodiment of a photo-switchable light-emitting element.

### DETAILED DESCRIPTION

The present invention will be described more fully hereinafter with reference to the accompanying drawings, in which various embodiments are shown. This invention may, however, be embodied in many different forms and should not be construed as limited to the exemplary embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of the present invention.

The terminology used herein is for the purpose of describing particular embodiments only and is not intended to be limiting. As used herein, the singular forms “a,” “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims

As used herein, unless provided otherwise, the term “substituted” refers to a compound or radical substituted with at least one (e.g., 1, 2, 3, 4, 5, 6 or more) substituents independently selected from a halide, a C₁-C₂₀ haloalkyl group, a C₁-C₂₀ alkyl group, a C₁-C₂₀ alkoxy group, a C₆-C₃₀ aryl group, a C₆-C₃₀ aryloxy group, or a combination thereof, instead of hydrogen, provided that the substituted atom's normal valence is not exceeded.

As used herein, unless otherwise provided, “phosphine” has the general formula P(R)₃, wherein each R is independently hydrogen, an alkyl group, or an aryl group.

“Alkyl,” as used herein, refers to a straight or branched chain saturated aliphatic hydrocarbon. Alkyl groups include, for example, groups having from 1 to 50 carbon atoms (C1-C50 alkyl).

As used herein, unless otherwise provided, “aryl,” as used herein means a cyclic moiety in which all ring members are carbon and at least one ring is aromatic. More than one ring may be present, and any additional rings may be independently aromatic, saturated or partially unsaturated, and may be fused, pendant, spirocyclic or a combination thereof.

“Alkoxy,” as used herein, refers to an alkyl moiety that is linked via an oxygen (i.e., —O-alkyl).

As used herein, unless otherwise provided, “amine” has the general formula NRR, wherein each R is independently hydrogen, an alkyl group, or an aryl group.

As used herein, unless otherwise provided, “Aryloxy,” as used herein, refers to an aryl moiety that is linked via an oxygen (i.e., —O-aryl).

As used herein, unless otherwise provided, “Haloalkyl” refers to an alkyl group in which at least one hydrogen is replaced with a halide.

As used herein, unless otherwise provided, “oxy” as used herein refers to a bivalent oxygen moiety.

As used herein, unless otherwise provided, a “primary amino group” means a monovalent group having the formula —NH₂.

As used herein, unless otherwise provided, a “secondary amino group” means a monovalent group having the formula —NHR, wherein R is an alkyl group, an aryl group, or the like.

As used herein, unless otherwise provided, the term “sulfonyl group” means a monovalent group having the formula —SO₂H.

As used herein, unless otherwise provided, the term “phosphonyl group” means a group having the formula —P(O)(OH)₂.

Hereinafter, a method of manufacturing a semiconductor nanocrystal is disclosed in further detail.

The semiconductor nanocrystal comprising a core, or a core and a shell, is manufactured by contacting (e.g., reacting) (A) a Group II precursor bound with phosphine, a Group III precursor bound with phosphine, or a mixture thereof with (B) a Group V compound, a Group VI compound, or a mixture thereof, to provide the core or the core and the shell of the semiconductor nanocrystal.

For example, the method may use either a Group II precursor bound with phosphine, or a Group III precursor bound with phosphine, or the method may include use of both of the Group II precursor bound with phosphine and the Group III precursor bound with phosphine. In addition, the method may use at least one of a Group V compound or a Group VI compound.

A Group II compound may include a carboxylate, carbonate, halide, nitrate, phosphate, sulfate, or the like that is bound to a Group II element such as Zn, Cd, Hg, or the like.

A Group III compound may include a carboxylate, carbonate, halide, nitrate, phosphate, sulfate, alkane, or the like that is bound to a Group III element such as Al, Ga, In, Ti, or the like. A Group V compound may include a carboxylate, carbonate, halide, nitrate, phosphate, sulfate, trimethylsilane (“TMS”), or the like that is bound to a Group V element such as P, As, Sb, Bi, or the like. A Group VI compound may include a carboxylate, carbonate, halide, nitrate, phosphate, sulfate, phosphine, or the like that is bound to a Group VI element such as O, S, Se, Te, or the like.

The Group II precursor bound with phosphine or the Group III precursor bound with phosphine may be represented by the following Chemical Formula 1.

Chemical Formula 1

MK_{y}(PHₓL_{3-X})_{z}

In Chemical Formula 1, M is a Group II element or Group III element, K is a carboxyl group, a phosphonyl group, an amino group, a sulfonyl group, a halide, a substituted or unsubstituted C₁-C₂₀ alkyl group, a substituted or unsubstituted C₁-C₂₀ alkoxy group, a substituted or unsubstituted C₆-C₃₀ aryl group, a substituted or unsubstituted C₆-C₃₀ aryloxy group, a substituted or unsubstituted C₁-C₂₀ haloalkyl group, or a combination thereof, L is a substituted or unsubstituted C₁-C₂₀ alkyl group, a substituted or unsubstituted C₁-C₂₀ alkoxy group, a substituted or unsubstituted C₆-C₃₀ aryl group, a substituted or unsubstituted C₆-C₃₀ aryloxy group, an oxy group, a halide, a substituted or unsubstituted C₁-C₂₀ haloalkyl group, a primary amino group, a secondary amino group, or a combination thereof, x is 0, 1, 2, or 3, y and z are each independently equal to or more than 0, provided that y+z is a real number from 3 to 5, and wherein each PHₓL₃₋ₓ group, each, K and each L is independently the same or different.

For example, K may be a carboxyl group or a phosphonyl group.

For example, M may be In, K may be a carboxyl group derived from palmitic acid, PHₓL₃₋ₓ may be trioctylphosphine, and y may be 3 and z may be 1, or y may be 2 and z may be 2, and y and z may be a number other than an integer. Thus the above Chemical Formula 1 may represent various kinds of compounds. In addition, M may be In, and the In may be bound with three carboxyl groups derived from palmitic acid, one trioctylphosphine, and one dibutylphosphine. In the embodiment including trioctylphosphine, x may be 0, and in the embodiment including dibutylphosphine, x may be 1, y may be 3, and z may be 2. In an embodiment, X is 0, and in another embodiment, x is 1, y is 3, and z is 2. Alternatively, M is In, and the In is bound with one carboxyl group derived from palmitic acid, one carboxyl group derived from octanoic acid, and one trioctylphosphine. In this embodiment, x may be 0, y may be 2, and z may be 1. In an embodiment, x is 0, y is 2, and z is 1.

In PHₓL₃₋ₓ, each L, which is bound to phosphorous, may be different from each other. For example, one phenyl group, one butyl group, one ethoxy group may be bound to P, and x may be 0.

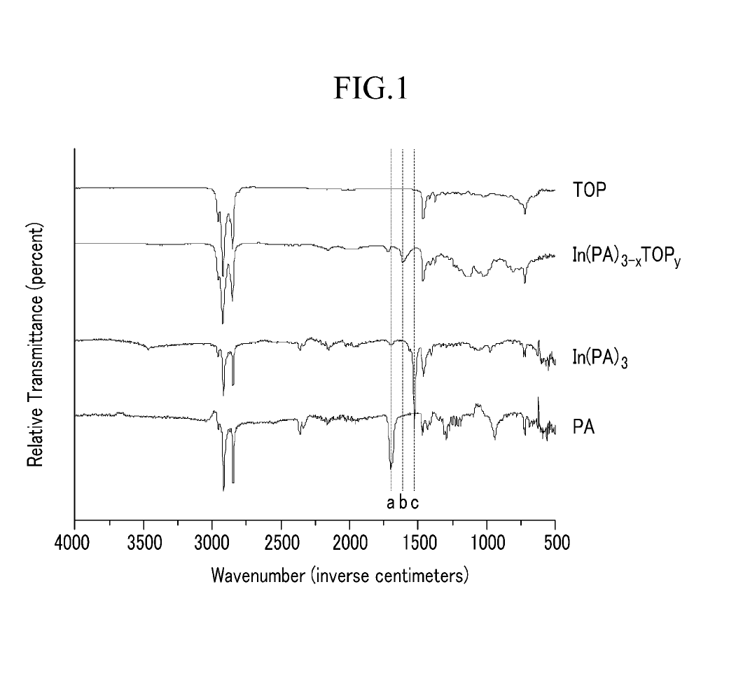

Referring to FIG. 1, the binding relationship of the Group III precursor bound with phosphine will be further disclosed.

FIG. 1 represents the infrared (“IR”) spectrum of an In precursor. In FIG. 1, PA is palmitic acid, TOP is trioctylphosphine, In(PA)₃ is a compound in which In is bound with a functional group derived from palmitic acid, and In(PA)₃₋ₓTOP_{y} is an In precursor compound bound with phosphine. As a result, the electron density of In is changed due to TOP, so it is possible to control the reactivity of the In precursor with the Group V or Group VI compound. The phosphine compound has a σ-donor characteristic and gives electrons (e.g., electron density) to the metal through a sigma bond and a π-acceptor characteristic receiving electrons (e.g., electron density) from the metal through a π bond, simultaneously, when it is bound with the metal as a ligand. In addition, the phosphine compound controls the σ-donor characteristic and the π-acceptor characteristic depending upon the functional group bound to P, so that the electron density of the metal bound with phosphine and the reactivity thereof are changed. Accordingly, it is possible to minutely control the reactivity of the In precursor, by selecting the type of the phosphine compound and the binding amount with In, and to simultaneously enhance the reactivity with the Group V or Group VI compound. Accordingly, the reaction efficiency of the produced semiconductor nanocrystal may be enhanced, the full width at half maximum may decrease, and the reproducibility to semiconductor nanocrystals may increase.

Comparing PA to In(PA)₃, the intensity of the peak a corresponding to the COOH group of the PA is reduced by binding to In, and the intensity of the peak b corresponding to the In-PA bond increases. Comparing the spectra of In(PA)₃ and In(PA)₃₋ₓTOP_{y}, the In-PA bond is weakened by the binding of In and TOP, thus the peak c corresponding to the In-PA bond is shifted to a wavenumber which is higher than that of the peak b of In(PA)₃.

The Group II precursor bound with phosphine, the Group III precursor bound with phosphine, or a mixture thereof may be contacted with the Group V compound, the Group VI compound, or a mixture thereof according to a wet process. For example, it may be mixed with an organic solvent, a surfactant, or the like, or a combination thereof.

The organic solvent may include a strongly coordinating or weakly coordinating solvent, or a non-coordinating solvent. For example, the organic solvent may include at least one of an aromatic solvent such as chlorobenzene or the like, an alkane such as hexane, octane, or the like, a non-polar solvent such as methyl chloride or the like, or a polar solvent such as dimethyl formamide, tetrahydrofuran, or the like. Examples of the organic solvent include a C₆-C₂₄ primary alkyl amine which may be a strongly coordinating solvent, a C₆-C₂₄ secondary alkyl amine which may be a strongly coordinating solvent, a C₆-C₂₄ tertiary alkyl amine which may be a weakly coordinating solvent, a C₆-C₂₄ primary alcohol which may be a weakly coordinating solvent, a C₆-C₂₄ secondary alcohol which may be a weakly coordinating solvent, a C₆-C₂₄ tertiary alcohol which may be a weakly coordinating solvent, a C₆-C₂₄ ketone or ester which may be a weakly coordinating solvent, a C₆-C₂₄ hetero cyclic compound including nitrogen or sulfur which may be a weakly coordinating solvent, a C₆-C₂₄ alkane which may be a non-coordinating solvent, a C₆-C₂₄ alkene which may be a non-coordinating solvent, a C₆-C₂₄ alkyne which may be a non-coordinating solvent, a C₆-C₂₄ trialkylphosphine such as trioctylphosphine which may be a weakly coordinating solvent, a C₆-C₂₄ trialkyl phosphine oxide such as trioctylphosphine oxide which may be a strongly coordinating solvent, or the like, or a combination thereof.

The surfactant may comprise a saturated or unsaturated C₆-C₂₄ carboxylic acid, a saturated or unsaturated C₆-C₂₄ phosphate, a saturated or unsaturated C₆-C₂₄ sulfate, a saturated or unsaturated C₆-C₂₄ sulfonate, a saturated or unsaturated C₆-C₂₄ amine, or a combination thereof. Examples of the surfactant include oleic acid, stearic acid, palmitic acid, hexyl phosphonic acid, n-octyl phosphonic acid, tetradecyl phosphonic acid, octadecylphosphonic acid, n-octyl amine, hexadecylamine, or the like, or a combination thereof.

The semiconductor nanocrystal may be bound with an organic ligand.

The organic ligand may be physically or chemically bound with the semiconductor nanocrystal, and may be a material having a non-covalent electron pair or having a functional group capable of bonding to a metal. For example, the functional group may include a thiol group, an amino group, a carboxyl group, a phosphine group, a phosphine oxide group, or a combination thereof. The organic ligand may be a substituted or unsubstituted hydrocarbon compound having a weight average molecular weight of about 10 to about 1,000,000 Daltons, specifically about 100 to about 100,000 Daltons, more specifically about 1000 to about 10,000 Daltons. For example, the hydrocarbon compound may include an alkane, alkene, alkyne, aromatic hydrocarbon, or a combination thereof. Particularly, the organic ligand may have a polydispersity index (“PDI”), which may be determined as a weight average molecular weight per number average molecular weight, of less than approximately 2, specifically less than or equal to about 1.5, more specifically less than or equal to about 1.

The organic ligand may be represented by the following Chemical Formula 2.

Chemical Formula 2

X—R—Y

In Chemical Formula 2, R is a hydrocarbon group, X is SH, PH₃, R′R″P═O wherein R′ and R″ are each independently a C₁-C₅ alkyl group, NH₂, or COOH, and Y is H, OH, NR′R″ wherein R′ and R″ are each independently a C₁-C₅ alkyl group, NH₂, COOH, or SO₃H.

In the organic ligand, X may be physically or chemically bound with the semiconductor nanocrystal.

Non-limiting examples of the organic ligand may include, but are not limited to, a thiol such as methane thiol, ethane thiol, propane thiol, butane thiol, pentane thiol, hexane thiol, octane thiol, dodecane thiol, hexadecane thiol, octadecane thiol, benzyl thiol, or the like, or a combination thereof; a mercapto alcohol such as mercapto methanol, mercapto ethanol, mercapto propanol, mercapto butanol, mercapto pentenol, mercapto hexanol, or the like, or a combination thereof; a mercapto carbonic acid such as mercapto acetic acid, mercapto propionic acid, mercapto butanoic acid, mercapto hexanoic acid, mercapto heptane, or the like, or a combination thereof; a mercapto sulfonic acid such as mercapto methane sulfonic acid, mercapto ethane sulfonic acid, mercapto propane sulfonic acid, mercapto benzene sulfonic acid, or the like, or a combination thereof; a mercapto amine such as mercapto methane amine, mercapto ethane amine, mercapto propane amine, mercapto butane amine, mercapto pentane amine, mercapto hexane amine, mercapto pyridine, or the like, or a combination thereof; a mercapto spacer thiol such as mercapto methyl thiol, mercapto ethyl thiol, mercapto propyl thiol, mercapto butyl thiol, mercapto pentyl thiol, or the like, or a combination thereof; an amine such as methane amine, ethane amine, propane amine, butane amine, pentane amine, hexane amine, octane amine, dodecane amine, hexadecyl amine, octadecyl amine, dimethyl amine, diethyl amine, dipropyl amine, or the like, or a combination thereof; an amino alcohol such as amino methanol, amino ethanol, amino propanol, amino butanol, amino pentenol, amino hexanol, or the like, or a combination thereof; an amino carbonic acid such as amino acetic acid, amino propionic acid, amino butanoic acid, amino hexanoic acid, amino heptane, or the like, or a combination thereof; an amino sulfonic acid such as amino methane sulfonic acid, amino ethane sulfonic acid, amino propane sulfonic acid, amino benzene sulfonic acid, or the like; an amino amine or diamine such as amino methane amine, amino ethane amine, amino propane amine, amino butyl amine, amino pentyl amine, amino hexyl amine, amino benzene amine, amino pyridine, or the like, or a combination thereof; a carboxylic acid such as methanoic acid, ethanoic acid, propanoic acid, butanoic acid, pentanoic acid, hexanoic acid, heptanoic acid, octanoic acid, dodecanoic acid, hexadecanoic acid, octadecanoic acid, oleic acid, benzoic acid, or the like, or a combination thereof; a carboxylic acid alcohol such as carboxylic acid methanol, carboxylic acid ethanol, carboxylic acid propanol, carboxylic acid butanol, carboxylic acid pentenol, carboxylic acid hexanol, or the like, or a combination thereof; a carboxylic acid sulfonic acid such as carboxylic acid methane sulfonic acid, carboxylic acid ethane sulfonic acid, carboxylic acid propane sulfonic acid, carboxylic acid benzene sulfonic acid, or the like, or a combination thereof; a carboxylic acid carboxylic acid such as carboxylic acid methane carboxylic acid, carboxylic acid ethane carboxylic acid, carboxylic acid propane carboxylic acid, carboxylic acid propane carboxylic acid, carboxylic acid benzene carboxylic acid, or the like, or a combination thereof; a phosphine such as methyl phosphine, ethyl phosphine, propyl phosphine, butyl phosphine, pentyl phosphine, or the like, or a combination thereof; a phosphine alcohol such as phosphine methanol, phosphine ethanol, phosphine propanol, phosphine butanol, phosphine pentenol, phosphine hexanol, or the like, or a combination thereof; a phosphine sulfonic acid such as phosphine methane sulfonic acid, phosphine ethane sulfonic acid, phosphine propane sulfonic acid, phosphine benzene sulfonic acid, or the like; a phosphine carboxylic acid such as phosphine methane carboxylic acid, phosphine ethane carboxylic acid, phosphine propane carboxylic acid, phosphine benzene carboxylic acid, or the like, or a combination thereof; a phosphine amine such as phosphine methane amine, phosphine ethane amine, phosphine propane amine, phosphine benzene amine, or the like; a phosphine oxide such as methyl phosphine oxide, ethyl phosphine oxide, propyl phosphine oxide, butyl phosphine oxide, or the like; a phosphine oxide alcohol such as phosphine oxide methanol, phosphine oxide ethanol, phosphine oxide propanol, phosphine oxide butanol, phosphine oxide pentenol, phosphine oxide hexanol, or the like, or a combination thereof; a phosphine oxide sulfonic acid such as phosphine oxide methane sulfonic acid, phosphine oxide ethane sulfonic acid, phosphine oxide propane sulfonic acid, phosphine oxide benzene sulfonic acid, or the like, or a combination thereof; a phosphine oxide carboxylic acid such as phosphine oxide methane carboxylic acid, phosphine oxide ethane carboxylic acid, phosphine oxide propane carboxylic acid, phosphine oxide benzene carboxylic acid, or the like, or a combination thereof; or a phosphine oxide spacer amine such as phosphine oxide methane amine, phosphine oxide ethane amine, phosphine oxide propane amine, phosphine oxide benzene amine, or the like, or a combination thereof; or a combination thereof.

Non-limiting examples of the spacer include a C₁ to C₁₆ alkylene, a C₆ to C₂₄ arylene, or a combination thereof.

The Group III precursor bound with phosphine may be prepared by mixing a Group III compound and a phosphine compound. In addition, the Group II precursor bound with phosphine may be prepared by mixing a Group II compound and a phosphine compound.

The phosphine compound may be represented by the following Chemical Formula 3.

Chemical Formula 3

PHₓL₃₋ₓ

In the above Chemical Formula 3, L is a substituted or unsubstituted C₁-C₂₀ alkyl group, a substituted or unsubstituted C₁-C₂₀ alkoxy group, a substituted or unsubstituted C₆-C₃₀ aryl group, a substituted or unsubstituted C₆-C₃₀ aryloxy group, an oxy group, a halide, a substituted or unsubstituted C₁-C₂₀ haloalkyl group, a primary amino group, a secondary amino group, or a combination thereof, x is 0, 1, 2, or 3, and each L is independently the same or different.

In an embodiment, one phenyl group, one butyl group, and one ethoxy group may be bound to P, and x may be 0.

For example, the phosphine compound may include an alkyl phosphine such as tributyl phosphine, dibutyl phosphine, trioctyl phosphine, dioctyl phosphine, or the like, an aromatic phosphine such as triphenyl phosphine, diphenyl phosphine, or the like, or an alkyl phosphite such as triethylphosphite, dibutylphosphite, or the like, or a combination thereof.

A transition element may be alloyed in a core or a shell of the semiconductor nanocrystal. For example, before reacting the Group III or Group III compound with the phosphine compound, the Group III compound may be mixed with a transition element precursor. The transition element may include Zn, Mn, Cu, Fe, Ni, Co, Cr, V, Ti, Zr, Nb, Mo, Ru, Rh, Cd, or a combination thereof, but is not limited thereto.

During or after fabrication of a core of a semiconductor nanocrystal, the shell surrounding the core may be provided as a single layer or as a composite layer. For example, the shell may be a Group II-VI semiconductor, a Group III-V semiconductor, a Group IV semiconductor, or a Group IV-VI semiconductor, or a combination thereof. The Group II element may include Zn, Cd, Hg, or a combination thereof; the Group III element may include Al, Ga, In, Ti, or a combination thereof; the Group IV element may include Si, Ge, Sn, Pb, or a combination thereof; the Group V element may include P, As, Sb, Bi, or a combination thereof; and the Group VI element may include O, S, Se, Te, or a combination thereof.

The method of providing a shell of a semiconductor nanocrystal may be applied based on the semiconductor nanocrystal having a core structure or a core-shell structure. For example, the method may include preparing an InP nanocrystal using a Group III precursor bound with phosphine to provide a core, and coating a ZnS shell on the core to provide an InP/ZnS core-shell nanocrystal. In addition, using the Group III precursor bound with phosphine, a core-shell nanocrystal in which a shell of InP, GaP, or the like is surrounded on the core may be provided.

As used herein, a core means only a core without a shell. As used herein, a core-shell structure means a structure including a core and at least one shell partially or entirely surrounding the core. The core or the shell may independently be a Group II-VI semiconductor, a Group III-V semiconductor, a Group IV semiconductor, a Group IV-VI semiconductor, or a combination thereof.

When the semiconductor nanocrystal has a core-shell structure, the shell of the semiconductor nanocrystal may protect the core, and thereby the quantum efficiency of the semiconductor nanocrystal may be increased.

Hereinafter, a method of manufacturing a semiconductor nanocrystal according to an embodiment is disclosed in further detail.

The method of manufacturing a core of a semiconductor nanocrystal includes preparing a solution including (A) a Group II compound, a Group III compound, or a mixture thereof, (B) a phosphine compound, and (C) a surfactant, and adding (D) a Group V compound, a Group VI compound, or a mixture thereof into the solution to provide the core of the semiconductor nanocrystal. The preparation of the solution may be carried out by heating under an inert gas atmosphere. For example, the solution may be heated at about 100 to about 320 degrees Celsius (° C.), specifically about 150 to about 300° C., more specifically about 200 to about 250° C., for approximately 30 seconds to about 24 hours, specifically about 1 minute to about 20 hours, more specifically about 1 hour to about 10 hours. In addition, the adding of a Group V compound, a Group VI compound, or a mixture thereof to the solution may be performed at approximately 20 to about 300 degrees Celsius (° C.), specifically about 40 to about 250° C., more specifically about 80 to about 200° C.

The Group II compound, Group III compound, Group V compound, Group VI compound, phosphine compound, and the surfactant are disclosed above, therefore further detailed description is omitted. In addition, the core of the semiconductor nanocrystal may be provided separately; or the shell of the semiconductor nanocrystal, which is coated on the core of the core-shell structure, may be provided separately. The providing of the core and shell are described above, therefore further detailed description is omitted.

Furthermore, an organic solvent may be used, an organic ligand may be bound to the semiconductor nanocrystal, and a transition element precursor may be mixed together with the Group II or Group III compound. This is also described above, therefore further detailed description is omitted.

Because the phosphine compound is mixed with the Group II or Group III compound, the reactivity of In with the Group V or Group VI compound may be controlled, the reaction efficiency of the semiconductor nanocrystal may be enhanced, and the full width at half maximum may be reduced.

Hereinafter, a method of manufacturing a semiconductor nanocrystal according to another embodiment is disclosed in further detail.

A method of manufacturing a shell of a semiconductor nanocrystal includes providing a solution including (A) a Group II compound, a Group III compound, or a mixture thereof, (B) a phosphine compound, and (C) a surfactant, and adding a mixture comprising (D) a Group V compound, a Group VI compound, or a mixture thereof to the solution to provide the shell of the semiconductor nanocrystal on a core, wherein the core is formed from the solution comprising (A) a Group II compound, a Group III compound, or a mixture thereof, (B) a phosphine compound, and (C) a surfactant, and (D) a Group V compound, a Group VI compound, or a mixture thereof, or the core is provided separately. The preparation of the solution may include heating under an inert gas atmosphere. For example, the solution may be heated at about 100 to about 320 degrees Celsius, specifically about 150 to about 300° C., more specifically about 200 to about 250° C., for approximately 30 seconds to about 24 hours, specifically about 1 minute to about 20 hours, more specifically about 1 hour to about 10 hours. The adding of a Group V compound, a Group VI compound, or a mixture thereof to the solution may be performed at approximately 20 to about 300 degrees Celsius, specifically about 40 to about 250° C., more specifically about 80 to about 200° C. The core may include a Group II-VI semiconductor, a Group III-V semiconductor, a Group IV semiconductor, a Group IV-VI semiconductor, a metal, or a mixture thereof.

The Group II compound, Group III compound, Group V compound, Group VI compound, phosphine compound, and the surfactant are the same as disclosed above, therefore further detailed description is omitted. Alternatively, the core of the semiconductor nanocrystal may be manufactured separately, or the shell of the semiconductor nanocrystal coated on the core structure, or the core-shell structure may be manufactured separately. The process is described above, therefore further detailed description is omitted.

In addition, an organic solvent may be used, the organic ligand may be bound to the semiconductor nanocrystal, and the transition element precursor may be mixed together with a Group II or Group III compound. This is also described above, therefore further detailed description is omitted.

Because the phosphine compound is mixed with a Group II or Group III compound, it may control the reactivity of In with the Group V or Group VI compound, may enhance the reaction efficiency of the semiconductor nanocrystal, and may decrease the full width at half maximum.

Hereinafter, a composition for a semiconductor nanocrystal according to another embodiment is disclosed.

The composition for a semiconductor nanocrystal includes a Group II precursor bound with phosphine, a Group III precursor bound with phosphine, or a mixture thereof, and a surfactant.

The composition for a semiconductor nanocrystal may further include at least one of a Group V compound, a Group VI compound, an organic solvent, or a transition element precursor.

The Group II precursor bound with phosphine, Group III precursor, surfactant, Group V or Group VI compound, organic solvent, and transition element precursor are described above, therefore further detailed description is omitted.

Because the composition includes a Group II precursor bound with phosphine or a Group III precursor bound with phosphine, it is possible to control the reactivity of In with the Group V or Group VI compound, to enhance the reaction efficiency of the semiconductor nanocrystal, and to decrease the full width at half maximum.

Hereinafter, a semiconductor nanocrystal composite is disclosed.

In the semiconductor nanocrystal composite, a semiconductor nanocrystal is disposed in a matrix. The matrix may comprise an organic material, an inorganic material, or a mixture thereof. For example, the matrix may include an organic polymer, a polysiloxane, silica, alumina, an epoxy, silicone, or the like, or a combination thereof.

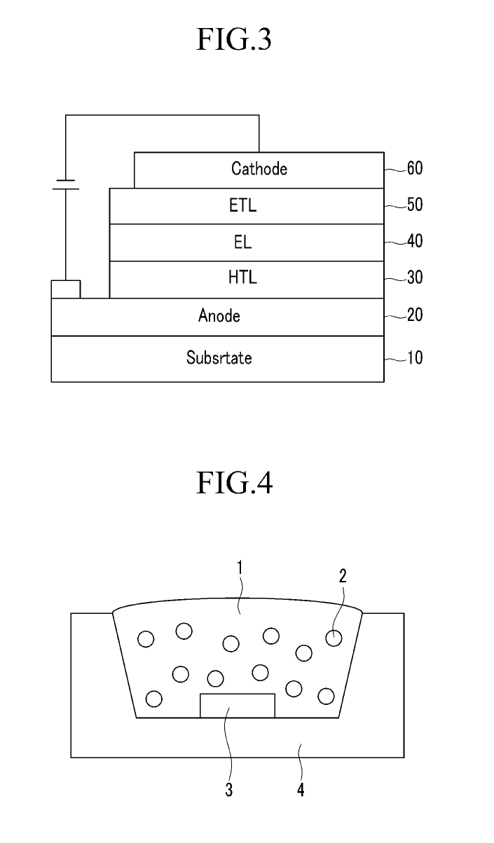

In light emitting element including a light emitting material comprising a semiconductor nanocrystal, an electrically driven light emitting element, which includes a light emitting material comprising a semiconductor nanocrystal, is disclosed with reference to FIG. 3.

FIG. 3 is a cross-sectional view of an exemplary embodiment of a light emitting device including a semiconductor nanocrystal.

Non-limiting examples of a light emitting device include an organic light emitting diode (“OLED”). Generally, an OLED is fabricated by forming an organic emission layer between two electrodes, and injecting an electron and a hole from the electrodes, respectively, into the organic emission layer to thereby produce an exciton based on the bonding between the electron and hole. Light is generated when the exciton falls to a ground state from the exited state.

For example, as illustrated in FIG. 3, an OLED comprises an anode 20 on an organic substrate 10. The anode 20 may comprise a material having a high work function so that the hole can be injected. Non-limiting examples of the material for the anode 20 include indium tin oxide (“ITO”) or another transparent oxide of indium oxide.

On the anode 20, a hole transport layer (“HTL”) 30, an emission layer (“EL”) 40, and an electron transport layer (“ETL”) 50 are sequentially disposed. The hole transport layer 30 may include a p-type semiconductor, and the electron transport layer 50 may include an n-type semiconductor or a metal oxide. The emission layer 40 may include a nanocrystals prepared according to an embodiment.

A cathode 60 is disposed on the electron transport layer 50. The cathode 60 may comprise a material having a low work function so that an electron can be easily injected into the electron transport layer 50. Non-limiting examples of the material for the cathode 60 include magnesium, calcium, sodium, potassium, titanium, indium, yttrium, lithium, gadolinium, aluminum, silver, tin, lead, cesium, barium, an alloy thereof, or a combination thereof, or a multi-layered material such as LiF/Al, LiO₂/Al, LiF/Ca, LiF/Al, or BaF₂/Ca, or a combination thereof. Because a method for fabricating the anode 20, the hole transport layer 30, the emission layer 40, the electron transport layer 50, and the cathode 60 and a method for assembling the foregoing are widely known to those skilled in the art, these methods will not be described in further detail in this disclosure.

As another example of a light emitting element including a light emitting material comprising a semiconductor nanocrystal, a light-transforming light emitting element including the light emitting material of the semiconductor nanocrystals is disclosed with reference to FIG. 4.

FIG. 4 is a cross-sectional view of an exemplary embodiment of a light-transforming emitting device.

A substrate 4 comprising Ag is disposed. The substrate 4 includes a recessed portion. A light emitting diode chip 3 emitting light corresponding to the blue or ultraviolet (“UV”) region is disposed on the substrate 4.

A matrix 1 including a semiconductor nanocrystal 2 is disposed on the light emitting diode chip 3. Herein, the semiconductor nanocrystal 3 may be a red, green, or blue emitting nanocrystal. Also, the matrix 1 may be an organic material or an inorganic material. The semiconductor nanocrystal 2 may be inserted into (e.g., included in) the matrix 1 which coats the recessed portion of the substrate 4 to thereby substantially cover the light emitting diode chip 3.

The semiconductor nanocrystal 2 may absorb the light emitting energy of the light emitting diode chip 3 and output the excited energy as a light of another wavelength. The light emitting wavelength of the semiconductor nanocrystal 2 may be selected, and the semiconductor nanocrystal 2 may have excellent color purity. For example, when a red emitting nanocrystals and a green emitting nanocrystal are combined with a blue light emitting diode chip, a white light emitting diode may be fabricated. Also, when a red emitting, a green emitting, and a blue emitting nanocrystal are combined with an ultraviolet (“UV”) light emitting diode chip, a white light emitting diode may be fabricated. In addition, when a nanocrystal capable of emitting light of a broad range of wavelengths is combined with a light emitting diode chip, a light emitting diode emitting light of a broad range wavelengths may be fabricated.

Hereafter, representative embodiments will be disclosed in further detail with reference to examples, but the following examples are only illustrative and shall not be limiting.

### Example 1

### Example 1-1

Indium acetate (0.75 millimoles, mmol), palmitic acid (2.25 mmol), and octadecene (15 milliliters, mL) are mixed and heated to 120° C. under vacuum and maintained at the temperature for one hour. A 2 mL quantity of trioctylphosphine is added thereto and heated to 320° C. and then cooled.

### Example 1-2

The solution obtained from Example 1-1, 0.38 mmol of trimethylsilyl-3-phosphine, 1 mmol of trioctylphosphine, and 0.4 mL of octadecene are mixed.

### Example 1-3

A 0.3 mmol quantity of trimethylsilyl-3-phosphine is mixed with 1.8 mmol of trioctylphosphine and 0.1 mL of octadecene to provide an injection solution. Indium acetate (0.6 mmol), palmitic acid (1.8 mmol), and octadecene (30 mL) are mixed and heated to 120° C. under vacuum and maintained at the temperature for one hour, then heated to 280° C., and then the injection solution is rapidly injected thereto. The resulting mixture is reacted for one hour after the injection. A 10 mL quantity of the solution obtained from Example 1-2 is slowly injected for 20 minutes and rapidly cooled to room temperature. Then acetone is added to the cooled mixture to precipitate nanocrystals. The precipitate is dissolved in 1 mL of toluene to provide a nanocrystal solution.

### Example 1-4

A 1.5 mL quantity of a 0.4 M sulfur/trioctylphosphine solution and 1 mL of a nanocrystal solution obtained from Example 1-3 are injected into a mixture of heated zinc acetate (0.3 mmol), oleic acid (0.6 mmol), and octadecene (10 mL). The resulting mixture is reacted by heating to 300° C. for one hour and cooled to room temperature. The acetone is added to the cooled mixture to precipitate nanocrystals. The precipitate is dissolved in 1 mL of toluene to provide a nanocrystal solution.

### Example 2

### Example 2-1

The same method as in Example 1-1 is performed.

### Example 2-2

The same method as in Example 1-2 is performed.

### Example 2-3

The same method as in Example 1-3 is performed.

### Example 2-4

A 0.07 mL quantity of a 0.4 M of selenium/trioctylphosphine solution, 1 mL of the nanocrystal solution obtained from Example 2-3, and 1.5 mL of a sulfur/trioctylphosphine solution are injected into a mixture of which zinc acetate (0.3 mmol), oleic acid (0.6 mmol), and octadecene (10 mL) are heated and reacted at 300° C. for one hour and cooled to room temperature. Then acetone is added to the cooled mixture to precipitate nanocrystals. The precipitate is dissolved in 1 mL of toluene to provide a nanocrystal solution.

### Comparative Example 1

### Comparative Example 1-1

Indium acetate (0.75 mmol), palmitic acid (2.25 mmol), and octadecene (15 mL) are mixed and heated to 120° C. under vacuum and maintained at the temperature for one hour, and then cooled.

### Comparative Example 1-2

The solution obtained from Comparative Example 1-1 is mixed with 0.38 mmol of trimethylsilyl-3-phosphine, 1 mmol of trioctylphosphine, and 0.4 mL of octadecene.

### Comparative Example 1-3

A 0.3 mmol quantity of trimethylsilyl-3-phosphine is mixed with 1.8 mmol of trioctylphosphine and 0.1 mL of octadecene to provide an injection solution. Indium acetate (0.6 mmol), palmitic acid (1.8 mmol), and octadecene (30 mL) are mixed and heated to 120° C. under vacuum and maintained at the temperature for one hour. Then it is heated to 280° C., and the injection solution is rapidly injected. The resulting mixture is reacted for one hour after the injection. a 10 mL quantity of the solution obtained from Example 1-2 is slowly injected for 20 minutes and rapidly cooled to room temperature. Then acetone is added to the cooled mixture to precipitate nanocrystals. The precipitate is dissolved in 1 mL of toluene to provide a nanocrystal solution.

### Comparative Example 1-4

The same procedure as in Example 1-4 is performed, except that the nanocrystal solution obtained from Comparative Example 1-3 is used.

### Comparative Example 2

### Comparative Example 2-1

A 0.3 mmol quantity of trimethylsilyl-3-phosphine is mixed with 1.8 mmol of trioctylphosphine and 0.1 mL of octadecene to provide 2 batches of injection solutions. Indium acetate (0.6 mmol), palmitic acid (1.8 mmol), and octadecene (30 mL) are mixed and heated to 120° C. under vacuum and maintained at the temperature for one hour. Then it is heated to 280° C., and the injection solution is rapidly injected. The resulting mixture is reacted for one hour after the injection. A 0.2 mL quantity of the injection solution is slowly injected for 20 minutes and rapidly cooled to room temperature. Then acetone is added to the cooled mixture to precipitate nanocrystals. The precipitate is dissolved in 1 mL of toluene to provide a nanocrystal solution.

### Comparative Example 2-2

The same procedure as in Example 1-4 is performed, except that the nanocrystal solution obtained from Comparative Example 2-1 is used.

Each nanocrystal solution obtained from Example 1, Example 2, Comparative Example 1, and Comparative Example 2 is measured to determine luminous efficiency, a wavelength showing a maximum peak of light emitting spectrum, and a full width at half maximum (“FWHM”) of the light emitting spectrum. Each result is described in the following Table 1.

TABLE 1

| | Luminous efficiency | Maximum peak | FWHM |
|---|---|---|---|
| | (%) | (nm) | (nm) |
| Example 1 | 58 | 592 | 45 |
| Example 2 | 47 | 608 | 41 |
| Comparative | 48 | 598 | 51 |
| Example 1 | | | |
| Comparative | 45 | 607 | 58 |
| Example 2 | | | |

As shown in Table 1, Example 1 has higher luminous efficiency, and Examples 1 and 2 have a lower full width at half maximum compared to Comparative Examples 1 and 2.

### Example 3

### Example 3-1

Indium acetate (0.2 mmol), zinc acetate (0.1 mmol), palmitic acid (0.8 mmol), and octadecene (10 mL) are mixed and heated to 120° C. under vacuum and maintained at the temperature for one hour. A 0.5 mL quantity of trioctylphosphine is added and heated to 320° C., and then cooled.

### Example 3-2

A 0.2 mmol quantity of trimethylsilyl-3-phosphine is mixed with 0.5 mL of trioctylphosphine to provide an injection solution. The solution obtained from Example 3-1 and the injection solution are mixed and heated to 320° C. and rapidly cooled to room temperature. Then the cooled mixture is added with acetone to precipitate nanocrystals. The precipitate is dissolved in 1 mL of toluene to provide a nanocrystal solution.

### Example 3-3

The same procedure as in Example 1-4 is performed, except that the nanocrystal solution obtained from Example 3-2 is used.

### Example 4

### Example 4-1

The same method as in Example 3-1 is performed.

### Example 4-2

The same method as in Example 3-2 is performed.

### Example 4-3

The same procedure as in Example 2-4 is performed, except that the nanocrystal solution obtained from Example 4-2 is used.

### Example 5

### Example 5-1

Indium acetate (0.2 mmol), zinc acetate (0.1 mmol), palmitic acid (0.8 mmol), and octadecene (10 mL) are mixed and heated to 120° C. under vacuum and maintained at the temperature for one hour. Then the heated mixture is cooled to room temperature.

### Example 5-2

A 0.01 mmol quantity of dibutylphosphine, 0.2 mmol of trimethylsilyl-3-phosphine, and 0.5 mL of trioctylphosphine are mixed to provide an injection solution. The solution obtained from Example 5-1 and the injection solution are mixed and heated to 320° C. and rapidly cooled to room temperature. Then acetone is added to the cooled mixture to precipitate nanocrystals. The precipitate is dissolved in 1 mL of toluene to provide a nanocrystal solution.

### Example 5-3

The same procedure as in Example 1-4 is performed, except that the nanocrystal solution obtained from Example 5-2 is used.

### Example 6

### Example 6-1

The same method as in Example 5-1 is performed.

### Example 6-2

The same method as in Example 5-2 is performed.

### Example 6-3

The same procedure as in Example 2-4 is performed, except that the nanocrystal solution obtained from Example 6-2 is used.

### Comparative Example 3

### Comparative Example 3-1

Indium acetate (0.2 mmol), zinc acetate (0.1 mmol), palmitic acid (0.8 mmol), and octadecene (10 mL) are mixed and heated to 120° C. under vacuum and maintained at the temperature for one hour. Then the heated mixture is cooled to room temperature.

### Comparative Example 3-2

A 0.2 mmol quantity of trimethylsilyl-3-phosphine and 0.5 mL of trioctylphosphine are mixed to provide an injection solution. The solution obtained from Comparative Example 3-1 and the injection solution are mixed and heated to 320° C. and rapidly cooled to room temperature. Then acetone is added to the cooled mixture to precipitate nanocrystals. The precipitate is dissolved in 1 mL of toluene to provide a nanocrystal solution.

### Comparative Example 3-3

The same procedure as in Example 1-4 is performed, except that the nanocrystal solution obtained from Comparative Example 3-2 is used.

### Comparative Example 4

### Comparative Example 4-1

The same method as in Comparative Example 3-1 is performed.

### Comparative Example 4-2

The same method as in Comparative Example 3-2 is performed.

### Comparative Example 4-3

The same procedure as in Example 2-4 is performed, except that the nanocrystal solution obtained from Example 4-2 is used.

Each nanocrystal solution obtained from Examples 3 to 6, Comparative Example 3, and Comparative Example 4 is measured to determine luminous efficiency, a wavelength of peak light emission, and a full width at half maximum of the light emitting spectrum. Each result is described in the following Table 2.

TABLE 2

| | Luminous efficiency | | |
|---|---|---|---|
| | (%) | Peak wavelength (nm) | FWHM (nm) |
| Example 3 | 54 | 520 | 46 |
| Example 4 | 72 | 535 | 44 |
| Example 5 | 50 | 514 | 46 |
| Example 6 | 53 | 529 | 44 |
| Comparative | 40 | 502 | 44 |
| Example 3 | | | |
| Comparative | 45 | 527 | 46 |
| Example 4 | | | |

As shown in Table 2, Examples 3 to 6 have higher luminous efficiency compared to Comparative Examples 3 and 4, and Example 4 has remarkably improved luminous efficiency.

### Example 7

### Example 7-1

Indium acetate (0.2 mmol), palmitic acid (0.8 mmol), and octadecene (10 mL) are mixed and heated to 120° C. under vacuum and treated for one hour. Then the resulting mixture is added with 0.5 mL of trioctylphosphine and heated to 320° C. and cooled.

### Example 7-2

A 0.2 mmol quantity of trimethylsilyl-3-phosphine is mixed with 0.5 mL of trioctylphosphine to provide an injection solution. The solution obtained from Example 7-1 and the injection solution are mixed and heated to 320° C. and rapidly cooled to room temperature. Then acetone is added to the cooled mixture to precipitate nanocrystals. The precipitate is dissolved in 1 mL of toluene to provide a nanocrystal solution.

### Example 7-3

The same procedure as in Example 1-4 is performed, except that the nanocrystal solution obtained from Example 7-2 is used.

### Example 8

### Example 8-1

Indium acetate (0.2 mmol), palmitic acid (0.8 mmol), and octadecene (10 mL) are mixed and heated to 120° C. under vacuum and treated for one hour. Then it is added with 0.05 mmol of dibutylphosphine and 0.5 mL of trioctylphosphine and heated to 320° C. and cooled.

### Example 8-2

A 0.2 mmol quantity of trimethylsilyl-3-phosphine is mixed with 0.5 mL of trioctylphosphine to provide an injection solution. The solution obtained from Example 8-1 and the injection solution are mixed and heated to 320° C. and rapidly cooled to room temperature. Then acetone is added to the cooled mixture to precipitate nanocrystals. The precipitate is dissolved in 1 mL of toluene to provide a nanocrystal solution.

### Example 8-3

The same procedure as in Example 1-4 is performed, except that the nanocrystal solution obtained from Example 8-2 is used.

### Comparative Example 5

### Comparative Example 5-1

Indium acetate (0.2 mmol), palmitic acid (0.8 mmol), and octadecene (10 mL) are mixed and heated to 120° C. under vacuum and maintained at the temperature for one hour. Then the heated mixture is cooled to room temperature.

### Comparative Example 5-2

A 0.2 mmol quantity of trimethylsilyl-3-phosphine is mixed with 0.5 mL of trioctylphosphine to provide an injection solution. The solution obtained from Comparative Example 5-1 and the injection solution are mixed and heated to 320° C. and rapidly cooled to room temperature. Then acetone is added to the cooled mixture to precipitate nanocrystals. The precipitate is dissolved in 1 mL of toluene to provide a nanocrystal solution.

### Comparative Example 5-3

The same procedure as in Example 1-4 is performed, except that the nanocrystal solution obtained from Example 5-2 is used.

Each nanocrystal solution obtained from Example 7, Example 8, and Comparative Example 5 is measured to determine luminous efficiency, a wavelength of peak light emission, and a full width at half maximum of the light emitting spectrum. Each result is described in the following Table 3.

TABLE 3

| | Luminous efficiency | | |
|---|---|---|---|
| | (%) | Peak wavelength (nm) | FWHM (nm) |
| Example 7 | 70 | 545 | 46 |
| Example 8 | 64 | 572 | 60 |
| Comparative | 58 | 530 | 55 |
| Example 5 | | | |

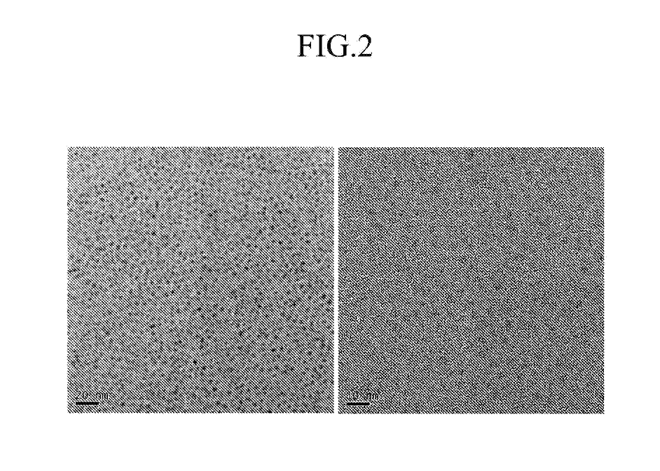

As shown in Table 3, Example 7 has a lower full width at half maximum and higher luminous efficiency compared to Comparative Example 5. FIG. 2 is an transmission electron micrograph showing that the nanocrystals of Example 2 are very uniform. The product of Example 8 shifts a light emitting wavelength into a red region, as compared to the product of Comparative Example 5, and enhances luminous efficiency.

While this disclosure has been described in connection with exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method of preparing a semiconductor nanocrystal comprising a core or a core and a shell, the method comprising:
contacting
(A) a Group II precursor bound with phosphine, a Group III precursor bound with phosphine, or a mixture thereof, and
(B) a Group V compound, a Group VI compound, or a mixture thereof, to provide the core or the shell of the semiconductor nanocrystal.

2. The method of claim 1, wherein at least one of the Group II precursor bound with phosphine or the Group III precursor bound with phosphine is represented by the following Chemical Formula 1:
Chemical Formula 1
MK_{y}(PHₓL₃₋ₓ)_{z}
wherein, in Chemical Formula 1,
M is a Group II element or Group III element,
K is a carboxyl group, a phosphonyl group, an amino group, a sulfonyl group, a halide, a substituted or unsubstituted C₁-C₂₀ alkyl group, a substituted or unsubstituted C₁-C₂₀ alkoxy group, a substituted or unsubstituted C₆-C₃₀ aryl group, a substituted or unsubstituted C₆-C₃₀ aryloxy group, a substituted or unsubstituted C₁-C₂₀ haloalkyl group, or a combination thereof,
L is a substituted or unsubstituted C₁-C₂₀ alkyl group, a substituted or unsubstituted C₁-C₂₀ alkoxy group, a substituted or unsubstituted C₆-C₃₀ aryl group, a substituted or unsubstituted C₆-C₃₀ aryloxy group, an oxy group, a halide, a substituted or unsubstituted C₁-C₂₀ haloalkyl group, a primary amino group, a secondary amino group, or a combination thereof,
x is 0, 1, 2, or 3,
y and z are each independently equal to or more than 0, provided that y+z is from 3 to 5, and
wherein each PHₓL₃₋ₓ group, each K, and each L is independently the same or different.

3. The method of claim 1, wherein the contacting is performed in a solvent.

4. The method of claim 1, further comprising contacting a Group III compound and a phosphine compound to provide the Group III precursor bound with phosphine, or contacting a Group II compound and a phosphine compound to provide the Group II precursor bound with phosphine.

5. The method of claim 1, further comprising alloying a transition element with at least one of the core or the shell.

6. The method of claim 5, wherein the transition element comprises Zn, Mn, Cu, Fe, Ni, Co, Cr, V, Ti, Zr, Nb, Mo, Ru, Rh, Cd, or a combination thereof.

7. The method of claim 1, further comprising binding an organic ligand represented by the following Chemical Formula 2 to the semiconductor nanocrystal:
Chemical Formula 2
X—R—Y
wherein, in Chemical Formula 2,
R is a hydrocarbon group,
X is SH, PH₃, R′R″P═O wherein R′ and R″ are each independently a C₁-C₅ alkyl group, NH₂, or COOH, and
Y is H, OH, NR′R″, NH₂, COOH, or SO₃H.

8. A method of manufacturing a core of a semiconductor nanocrystal, the method comprising:
preparing a solution comprising (A) a Group II compound, a Group III compound, or a mixture thereof, (B) a phosphine compound, and (C) a surfactant, and
adding (D) a Group V compound, a Group VI compound, or a mixture thereof to the solution to provide the core of the semiconductor nanocrystal.

9. The method of claim 8, wherein the phosphine compound is represented by the following Chemical Formula 3:
Chemical Formula 3
PHₓL₃₋ₓ
wherein, in Chemical Formula 3,
L is a substituted or unsubstituted C₁-C₂₀ alkyl group, a substituted or unsubstituted C₁-C₂₀ alkoxy group, a substituted or unsubstituted C₆-C₃₀ aryl group, a substituted or unsubstituted C₆-C₃₀ aryloxy group, an oxy group, a halide, a substituted or unsubstituted C₁-C₂₀ haloalkyl group, a primary amino group, a secondary amino group, or a combination thereof,
x is 0, 1, 2, or 3, and
each L is independently the same or different.

10. The method of claim 8, wherein the phosphine compound comprises tributyl phosphine, dibutyl phosphine, trioctyl phosphine, dioctyl phosphine, triphenyl phosphine, diphenyl phosphine, triethyl phosphite, dibutyl phosphite, or a mixture thereof.

11. The method of claim 8, wherein the surfactant comprises a saturated or unsaturated C₆-C₂₄ carboxylic acid, a saturated or unsaturated C₆-C₂₄ phosphate, a saturated or unsaturated C₆-C₂₄ sulfate, a saturated or unsaturated C₆-C₂₄ sulfonate, a saturated or unsaturated C₆-C₂₄ amine, or a combination thereof.

12. The method of claim 8, further comprising alloying a transition element with the core.

13. The method of claim 8, further comprising binding an organic ligand represented by the following Chemical Formula 2 to the semiconductor nanocrystal:
Chemical Formula 2
X—R—Y
wherein, in Chemical Formula 2,
R is a hydrocarbon group,
X is SH, PH₃, R′R″P═O wherein R′ and R″ are each independently a C₁-C₅ alkyl group, NH₂, or COOH, and
Y is H, OH, NR′R″, NH₂, COOH, or SO₃H.

14. A method of manufacturing a shell of a semiconductor nanocrystal, the method comprising:
providing a solution comprising (A) a Group II compound, a Group III compound, or a mixture thereof, (B) a phosphine compound, and (C) a surfactant, and
adding a mixture comprising (D) a Group V compound, a Group VI compound, or a mixture thereof to the solution to provide the shell on a core,
wherein the core is formed from the solution comprising (A) a Group II compound, a Group III compound, or a mixture thereof, (B) a phosphine compound, and (C) a surfactant, and (D) a Group V compound, a Group VI compound, or a mixture thereof, or the core is provided separately.

15. A method of claim 14, wherein the phosphine compound is represented by the following Chemical Formula 3:
Chemical Formula 3
PHₓL₃₋ₓ
wherein, in Chemical Formula 3,
L is a substituted or unsubstituted C₁-C₂₀ alkyl group, a substituted or unsubstituted C₁-C₂₀ alkoxy group, a substituted or unsubstituted C₆-C₃₀ aryl group, a substituted or unsubstituted C₆-C₃₀ aryloxy group, an oxy group, a halide, a substituted or unsubstituted C₁-C₂₀ haloalkyl group, a primary amino group, a secondary amino group, or a combination thereof,
x is 0, 1, 2, or 3, and
each L is independently the same or different.

16. The method of claim 14, wherein the phosphine compound comprises tributyl phosphine, dibutyl phosphine, trioctyl phosphine, dioctyl phosphine, triphenyl phosphine, diphenyl phosphine, triethyl phosphite, dibutyl phosphite, or a mixture thereof.

17. The method of claim 14, wherein the surfactant comprises a saturated or unsaturated C₆-C₂₄ carboxylic acid, a saturated or unsaturated C₆-C₂₄ phosphate, a saturated or unsaturated C₆-C₂₄ sulfate, a saturated or unsaturated C₆-C₂₄ sulfonate, a saturated or unsaturated C₆-C₂₄ amine, or a combination thereof.

18. The method of claim 14, further comprising alloying a transition element with at least one of the core or the shell.

19. The method of claim 14, wherein the core is a Group II-VI semiconductor, a Group III-V semiconductor, a Group IV semiconductor, a Group IV-VI semiconductor, a metal, or a mixture thereof.

20. The method of claim 14, wherein an organic ligand represented by the following Chemical Formula 2 is bound to the semiconductor nanocrystal:
Chemical Formula 2
X—R—Y
wherein, in Chemical Formula 2,
R is a hydrocarbon group,
X is SH, PH₃, R′R″P═O wherein R′ and R″ are each independently a C₁-C₅ alkyl group, NH₂, or COOH, and
Y is H, OH, NR′R″, NH₂, COOH, or SO₃H.

21. A semiconductor nanocrystal composition comprising:
a Group III precursor bound with phosphine, a Group II precursor bound with phosphine, or a mixture thereof, and
a surfactant.

22. The composition of claim 21, wherein the composition further comprises a Group V compound, a Group VI compound, or a mixture thereof.

23. The composition of claim 22, wherein the composition further comprises an organic solvent.

24. The composition of claim 21, wherein the composition further comprises a precursor comprising a transition element.

25. The composition of claim 21, wherein at least one of the Group II precursor bound with phosphine or the Group III precursor bound with phosphine is represented by the following Chemical Formula 1:
Chemical Formula 1
MK_{y}(PHₓL₃₋ₓ)_{Z}
wherein, in Chemical Formula 1,
M is a Group II element or Group III element,
K is a carboxyl group, a phosphonyl group, an amino group, a sulfonyl group, a halide, a substituted or unsubstituted C₁-C₂₀ alkyl group, a substituted or unsubstituted C₁-C₂₀ alkoxy group, a substituted or unsubstituted C₆-C₃₀ aryl group, a substituted or unsubstituted C₆-C₃₀ aryloxy group, a substituted or unsubstituted C₁-C₂₀ haloalkyl group, or a combination thereof,
L is a substituted or unsubstituted C₁-C₂₀ alkyl group, a substituted or unsubstituted C₁-C₂₀ alkoxy group, a substituted or unsubstituted C₆-C₃₀ aryl group, a substituted or unsubstituted C₆-C₃₀ aryloxy group, an oxy group, a halide, a substituted or unsubstituted C₁-C₂₀ haloalkyl group, a primary amino group, a secondary amino group, or a combination thereof,
x is 0, 1, 2, or 3,
y and z are each independently equal to or more than 0, provided that y+z is from 3 to 5, and wherein each PHₓL₃₋ₓ group, each K, and each L is independently the same or different.

26. The composition of claim 21, wherein the surfactant comprises saturated or unsaturated C₆-C₂₄ carboxylic acid, a saturated or unsaturated C₆-C₂₄ phosphate, a saturated or unsaturated C₆-C₂₄ sulfate, a saturated or unsaturated C₆-C₂₄ sulfonate, a saturated or unsaturated C₆-C₂₄ amine, or a combination thereof.

27. A semiconductor nanocrystal manufactured using the composition of claim 21.

28. A semiconductor nanocrystal composite, comprising the semiconductor nanocrystal manufactured using the composition of claim 21 disposed in a matrix.

29. A light emitting device comprising a semiconductor nanocrystal of claim 21.
